(19) United States
(12) Patent Application Publication
(10) Pub. No.: US 2019/0248281 A1
(43) Pub. Date: Aug. 15, 2019

(54) VEHICLE ILLUMINATION SYSTEM AND VEHICLE

(71) Applicant: KOITO MANUFACTURING CO., LTD., Tokyo (JP)

(72) Inventors: Yoshiaki Fushimi, Shizuoka (JP); Misako Kamiya, Shizuoka (JP); Naoki Takii, Shizuoka (JP)

(73) Assignee: KOITO MANUFACTURING CO., LTD., Tokyo (JP)

(21) Appl. No.: 16/277,456

(22) Filed: Feb. 15, 2019

(30) Foreign Application Priority Data
Feb. 15, 2018 (JP) 2018-025161

(51) Int. Cl. B60Q 1/50; B60Q 1/28; G05D 1/00

(52) U.S. Cl. CPC B60Q 1/50; B60Q 1/28; B60Q 2400/00; G05D 1/0061; G05D 1/0088

(57) ABSTRACT

A vehicle illumination system provided to a vehicle capable of traveling in an autonomous driving mode includes: an autonomous driving system (ADS) lamp configured to emit light toward an outside of the vehicle, thereby visually presenting information relating to an autonomous driving of the vehicle; and an illumination controller configured to change an illumination feature of the ADS lamp under a predetermined condition, in correspondence to a current traveling area in which the vehicle is currently located.

### CROSS-REFERENCE TO RELATED APPLICATION

This application is based on and claims priority under 35 USC 119 from Japanese Patent Application No. 2018-025161 filed on Feb. 15, 2018, the contents of which are incorporated herein by reference.

### TECHNICAL FIELD

The present disclosure relates to a vehicle illumination system. In particular, the present disclosure relates to a vehicle illumination system provided to a vehicle capable of traveling in an autonomous driving mode. Also, the present disclosure relates to a vehicle including the vehicle illumination system.

### BACKGROUND

Currently, research on an autonomous driving technology of an automobile has been actively conducted in each country, and each country is considering the legislation so as to enable a vehicle (hereinafter, a “vehicle” refer to an automobile) to travel in an autonomous driving mode on public roads. Here, in the autonomous driving mode, a vehicle system automatically controls traveling of a vehicle. Specifically, in the autonomous driving mode, the vehicle system automatically performs at least one of a steering control (control of a traveling direction of the vehicle), a brake control and an accelerator control (control of braking and acceleration/deceleration of the vehicle) based on information (surrounding environment information) indicative of a surrounding environment of the vehicle and obtained from sensors such as a camera, a radar (for example, a laser radar or a millimeter wave radar) and the like. On the other hand, in a manual driving mode to be described later, a driver controls the traveling of the vehicle, as in most of conventional vehicles. Specifically, in the manual driving mode, the traveling of the vehicle is controlled in conformity with a driver's operation (a steering operation, a braking operation, and an accelerator operation), and the vehicle system does not automatically perform the steering control, the brake control and the accelerator control. The driving mode of the vehicle is not a concept existing only in some vehicles but a concept existing in all vehicles including conventional vehicles having no autonomous driving function. For example, the driving mode of the vehicle is classified in accordance with a vehicle control method or the like.

Thus, in the future, it is expected that vehicles traveling in the autonomous driving mode (hereinafter, appropriately referred to as “autonomous driving vehicle”) and vehicles traveling in the manual driving mode (hereinafter, appropriately referred to as “manual driving vehicle”) coexist on public roads.

As an example of the autonomous driving technology, Patent Document 1 (Japanese Patent Application Laid-Open Publication No. H09-277887) discloses an automatic follow-up traveling system in which a following vehicle automatically follows a preceding vehicle. In the automatic follow-up traveling system, each of the preceding vehicle and the following vehicle has an illumination system, character information for preventing the other vehicle from intruding between the preceding vehicle and the following vehicle is displayed on the illumination system of the preceding vehicle, and character information indicative of the automatic follow-up traveling mode is displayed on the illumination system of the following vehicle.

In an autonomous driving society where the autonomous driving vehicles and the manual driving vehicles coexist, it is expected that an autonomous driving system lamp (hereinafter, referred to as ADS (Automated Driving System) lamp) configured to visually present information relating to the autonomous driving (for example, information relating to the autonomous driving mode of the vehicle) to a pedestrian and the other vehicle is to be mounted to the vehicle. In this case, since the pedestrian and the other vehicle can perceive a situation and an intention of the autonomous driving vehicle by visually recognizing an illumination feature of the ADS lamp, it is possible to reduce concerns about the autonomous driving vehicle.

It is assumed that an illumination specification of the ADS lamp is different in each traveling area. Here, in the illumination specification of the ADS lamp, an illumination feature (for example, turning on or off, an illumination color, a blinking cycle, a luminosity or the like) of the ADS lamp under a predetermined condition (for example, a case where the driving mode of the vehicle is changed and a case where the vehicle is stopped) is prescribed. For example, it is assumed that an illumination specification of a signal lamp (an example of the ADS lamp) is different between A country and B country. In this case, a vehicle having entered the B country from the A country cannot performcorrect visual communication with a pedestrian and the like in the B country.

Like this, in the upcoming autonomous driving society, there is room for further consideration of the change of the illumination specification of the ADS lamp, in correspondence to each traveling area.

The present disclosure is aimed at providing a vehicle illumination system and a vehicle capable of implementing optimal visual communication corresponding to each traveling area.

### SUMMARY

A vehicle illumination system related to one aspect of the present disclosure and provided to a vehicle capable of traveling in an autonomous driving mode includes: an autonomous driving system (ADS) lamp configured to emit light toward an outside of the vehicle; thereby visually presenting information relating to an autonomous driving of the vehicle; and an illumination controller configured to change an illumination feature of the ADS lamp under a predetermined condition, in correspondence to a current traveling area in which the vehicle is currently located.

Provided is a vehicle including a vehicle illumination system and capable of traveling in an autonomous driving mode. The vehicle illumination system includes: an autonomous driving system (ADS) lamp configured to emit light toward an outside of the vehicle, thereby visually presenting information relating to an autonomous driving of the vehicle; and an illumination controller configured to change an illumination feature of the ADS lamp under a predetermined condition, in correspondence to a current traveling area in which the vehicle is currently located.

It becomes possible to provide a vehicle illumination system and a vehicle capable of implementing optimal visual communication corresponding to each traveling area.

### BRIEF DESCRIPTION OF DRAWINGS

Exemplary embodiments of the present invention will be described in detail based on the following figures, wherein:

FIG. 1 is a front view of a vehicle having a vehicle illumination system in accordance with an illustrative embodiment of the present disclosure (hereinafter, simply referred to as ‘illustrative embodiment’);

FIG. 2 is a block diagram depicting a vehicle system having the vehicle illumination system of the illustrative embodiment;

FIG. 3 is a flowchart depicting a first operation example of the vehicle system.

FIG. 4 depicts the vehicle located in a current traveling area R1;

FIG. 5 is a flowchart depicting a second operation example of the vehicle system;

FIG. 6 depicts the vehicle located in the current traveling area R1 and an external server provided on a communication network;

FIG. 7 depicts the vehicle located in the current traveling area R1 and the infrastructure equipment configured to perform wireless communication with the vehicle;

FIG. 8 is a flowchart depicting an operation example of the vehicle system, which is executed when the vehicle travels on an autonomous driving vehicle road;

FIG. 9 depicts the vehicle passing an entry of the autonomous driving vehicle road;

FIG. 10 is a flowchart depicting an operation example of the vehicle system, which is executed when the vehicle travels in a theme-park; and

FIG. 11 depicts the vehicle passing an entry of the theme-park.

### DETAILED DESCRIPTION

Hereinafter, an illustrative embodiment of the present disclosure (hereinafter, referred to as ‘illustrative embodiment’) will be described with reference to the drawings. For the sake of convenience of description, dimensions of the respective members shown in the drawings may be different from actual dimensions of the respective members.

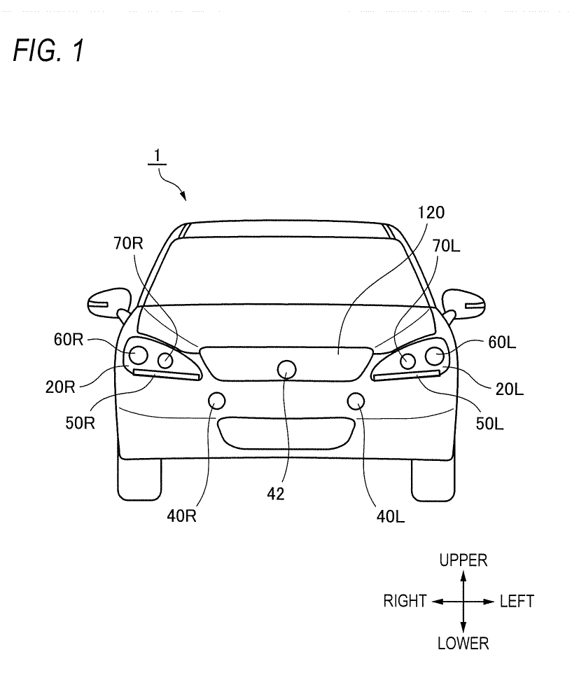

Also, in the description of the illustrative embodiment, for the sake of convenience of description, “the right and left direction”, “the upper and lower direction” and “the front and rear direction” will be appropriately mentioned. The directions are relative directions set with respect to a vehicle 1 shown in FIG. 1. Here, “the right and left direction” is a direction including “the rightward direction” and “the leftward direction”. “The upper and lower direction” is a direction including “the upward direction” and “the downward direction”. “The front and rear direction” is a direction including “the forward direction” and “the rearward direction”. Although not shown in FIG. 1, the front and rear direction is a direction perpendicular to the right and left direction and the upper and lower direction.

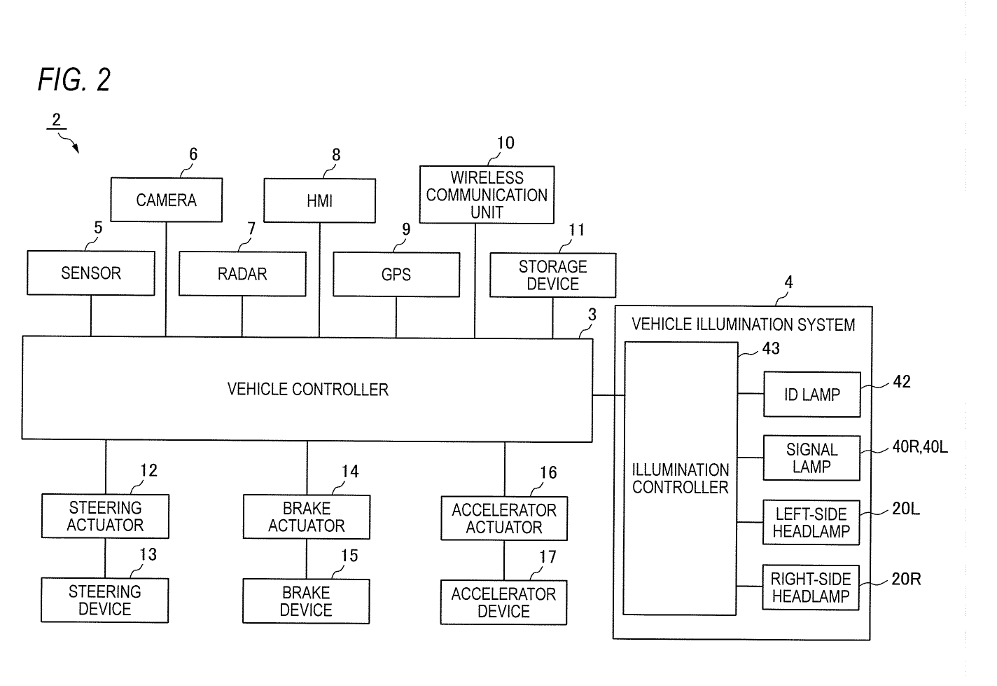

First, a vehicle illumination system 4 (hereinafter, simply referred to as “the illumination system 4”) of the illustrative embodiment is described with reference to FIGS. 1 and 2. FIG. 1 is a front view of the vehicle 1 having the illumination system 4 mounted thereto. FIG. 2 is a block diagram depicting a vehicle system 2 having the illumination system 4. The vehicle 1 is a vehicle (automobile) capable of traveling in an autonomous driving mode, and includes the vehicle system 2. The illumination system 4 includes a left-side headlamp 20L, a right-side headlamp 20R, an ID lamp 42, signal lamps 40R, 40L, and an illumination controller 43.

The left-side headlamp 20L is mounted to a front surface of the vehicle 1, and includes a low beam lamp 60L configured to emit a low beam toward the front of the vehicle 1, a high beam lamp 70L configured to emit a high beam toward the front of the vehicle 1, and a clearance lamp 50L. The low beam lamp 60L, the high beam lamp 70L and the clearance lamp 50L include one or more light-emitting elements such as an LED (Light Emitting Diode) and an LD (Laser Diode), and an optical member such as a lens, respectively. The low beam lamp 60L, the high beam lamp 70L and the clearance lamp SOL are mounted in a lamp chamber of the left-side headlamp 20L. The lamp chamber of the left-side headlamp 20L is formed by a lamp housing (not shown) and a transparent cover (not shown) mounted to the lamp housing.

The right-side headlamp 20R is mounted to the front surface of the vehicle 1, and includes a low beam lamp 60R configured to emit a low beam toward the front of the vehicle 1, a high beam lamp 70R configured to emit a high beam toward the front of the vehicle 1, and a clearance lamp 50R. The low beam lamp 60R, the high beam lamp 70R and the clearance lamp 50R include one or more light-emitting elements such as an LED (Light Emitting Diode) and an LD (Laser Diode), and an optical member such as a lens, respectively. The low beam lamp 60R, the high beam lamp 70R and the clearance lamp 50R are mounted in a lamp chamber of the right-side headlamp 20R. The lamp chamber of the right-side headlamp 20R is formed by a lamp housing (not shown) and a transparent cover (not shown) mounted to the lamp housing. In the below, for the sake of convenience of description, the left-side headlamp 20L and the right-side headlamp 20R may be simply referred to as the headlamp.

The ID lamp 42 is an example of the ADS lamp configured to emit light toward an outside of the vehicle 1, thereby visually presenting information relating to the autonomous driving of the vehicle 1. The ID lamp 42 is configured to emit light toward an outside of the vehicle 1, thereby visually presenting a driving mode of the vehicle 1. In particular, the ID lamp 42 is turned on when the driving mode of the vehicle 1 is an advanced driving support mode or a fully autonomous driving mode, and is turned off when the driving mode of the vehicle 1 is a driving support mode or a manual driving mode. In the meantime, the driving mode of the vehicle 1 will be described in detail later. The ID lamp 42 includes one or more light-emitting elements such as an LED and an LD, and an optical member such as a lens. The ID lamp 42 is arranged at a grill 120 of the vehicle 1. Also, an illumination color of the ID lamp 42 may be appropriately changed, in correspondence to a current traveling area (which will be described later) in which the vehicle 1 is currently located. In the meantime, the arrangement place or shape of the ID lamp 42 is not particularly limited.

The signal lamps 40L, 40R are examples of the ADS lamp and are configured to emit light toward the outside of the vehicle 1, thereby visually presenting an intention of the vehicle 1. In this respect, the signal lamps 40L, 40R can implement visual communication between the vehicle 1 and a target object (for example, the other vehicle, a pedestrian and the like) outside the vehicle 1 by changing an illumination feature thereof. For example, the signal lamps 40L, 40R may be blinked when giving way to the pedestrian. In this case, the pedestrian can recognize that the vehicle 1 is to give way to the pedestrian by seeing the blinking of the signal lamps 40L, 40R. Also, the signal lamps 40L, 40R may change the illumination features thereof (an illumination color, turning on or off, a blinking cycle, a luminosity or the like) when the vehicle 1 stops or starts or when the vehicle 1 changes traveling lanes. The signal lamps 40L, 40R include one or more light-emitting elements such as an LED and an LD, and an optical member such as a lens, respectively. The signal lamps 40L, 40R are arranged below the grill 120. In particular, the signal lamps 40L, 40R may be symmetrically arranged with respect to a central line of the vehicle 1. Also, the illumination features of the signal lamps 40L, 40R may be appropriately changed, in correspondence to the current traveling area (which will be described later). In the meantime, the arrangement place or shape of the signal lamps 40L, 40R is not particularly limited.

Subsequently, the vehicle system 2 of the vehicle 1 is described with reference to FIG. 2. FIG. 2 is a block diagram of the vehicle system 2. As shown in FIG. 2, the vehicle system 2 includes a vehicle controller 3, the illumination system 4, a sensor 5, a camera 6, a radar 7, an HMI (Human Machine Interface) 8, a GPS (Global Positioning System) 9, a wireless communication unit 10, and a storage device 11. In addition, the vehicle system 2 includes a steering actuator 12, a steering device 13, a brake actuator 14, a brake device 15, an accelerator actuator 16, and an accelerator device 17.

The vehicle controller 3 is configured to control traveling of the vehicle 1. The vehicle controller 3 is configured by, for example, at least one an electronic control unit (ECU). The electronic control unit includes a computer system (for example, SoC (System on a Chip) and the like) having one or more processors and one or more memories, and an electronic circuit having an active element such as a transistor and a passive element. The processor includes at least one of a CPU (Central Processing Unit), an MPU (Micro Processing Unit), a GPU (Graphics Processing Unit) and a TPU (Tensor Processing Unit), for example. The CPU may be configured by a plurality of CPU cores. The GPU may be configured by a plurality of GPU cores. The memory includes a ROM (Read Only Memory) and a RAM (Random Access Memory). In the ROM, a vehicle control program may be stored. For example, the vehicle control program may include an artificial intelligence (AI) program for autonomous driving. The AI program is a program established by a supervised or unsupervised machine learning (particularly, deep learning) using a multi-layered neural network. In the RAM, the vehicle control program, vehicle control data and/or surrounding environment information indicative of a surrounding environment of the vehicle may be temporarily stored. The processor may be configured to develop, on the RAM, a program designated from the diverse vehicle control programs stored in the ROM and to execute a variety of processes in cooperation with the RAM. Also, the computer system may be configured by a non-Neumann type computer such as an ASIC (Application Specific Integrated Circuit), an FPGA (Field-Programmable Gate Array) and the like. Also, the computer system may be configured by a combination of a Neumann type computer and a non-Neumann type computer.

As described above, the illumination system 4 includes the left-side headlamp 20L, the right-side headlamp 20R, the ID lamp 42, the signal lamps 40R, 40L, and the illumination controller 43. The illumination controller 43 is configured to control the illumination features (illumination aspects) of the left-side headlamp 20L, the right-side headlamp 20R, the ID lamp 42 and the signal lamps 40R, 40L.

For example, the illumination controller 43 is configured to control turning on or off of the ID lamp 42, in correspondence to the driving mode of the vehicle 1. Specifically, the illumination controller 43 turns on the ID lamp 42 when the driving mode of the vehicle 1 is the advanced driving support mode or the fully autonomous driving mode, and turns off the ID lamp 42 when the driving mode of the vehicle 1 is the manual driving mode or the driving support mode. Also, the illumination controller 43 is configured to control the illumination features of the signal lamps 40R, 40L so as to implement visual communication between the vehicle 1 and the target object (the pedestrian and the like). Also, the illumination controller 43 may be configured to switch the high beam and the low beam, in correspondence to surrounding environment information indicative of a surrounding environment of the vehicle 1.

The illumination controller 43 is configured by an electronic control unit (ECU) and is electrically connected to a power supply (not shown). The electronic control unit includes a computer system (for example, SoC and the like) having one or more processors and one or more memories, and an analog processing circuit having an active element such as a transistor and a passive element. The processor includes at least one of a CPU, an MPU, a GPU and a TPU, for example. The memory includes a ROM and a RAM. Also, the computer system may be configured by a non-Neumann type computer such as an ASIC, an FPGA and the like. The analog processing circuit includes a lamp drive circuit (for example, an LED driver and the like) configured to control drives of the left-side headlamp 20L, the right-side headlamp 20R, the ID lamp 42 and the signal lamps 40R, 40L. In the illustrative embodiment, the vehicle controller 3 and the illumination controller 43 are provided as separate configurations. However, the vehicle controller 3 and the illumination controller 43 may be integrally configured. In this respect, the illumination controller 43 and the vehicle controller 3 may be configured by a single electronic control unit.

The sensor 5 includes an acceleration sensor, a speed sensor, a gyro sensor, and the like. The sensor 5 is configured to detect a traveling condition of the vehicle 1 and to output traveling condition information to the vehicle controller 3. The sensor 5 may further include a seating sensor configured to detect whether a driver is sitting on a driver seat, a face direction sensor configured to detect a direction of a driver's face, an external weather sensor configured to detect an external weather condition, a passenger detection sensor configured to detect whether there is a passenger in a vehicle, a breath sensor configured to detect whether alcohol is included in a driver's breath, and the like.

The camera 6 is, for example, a camera including an imaging device such as a CCD (Charge-Coupled Device) and a CMOS (complementary MOS). The camera 6 is configured to acquire image data indicative of a surrounding environment of the vehicle 1 and to transmit the image data to the vehicle controller 3. The vehicle controller 3 is configured to acquire the surrounding environment information, based on the transmitted image data. Here, the surrounding environment information may include information about a target object (a pedestrian, the other vehicle, a marker and the like) existing at the outside of the vehicle 1. For example, the surrounding environment information may include information about attributes of the target object existing at the outside of the vehicle 1, and information about a distance and a position of the target object relative to the vehicle 1. The camera 6 may be configured as a monocular camera or a stereo camera.

The radar 7 is a millimeter wave radar, a microwave radar and/or a laser radar (for example, LiDAR). For example, the LiDAR unit is configured to detect the surrounding environment of the vehicle 1. In particular, the LiDAR unit is configured to acquire 3D mapping data (point group data) indicative of the surrounding environment of the vehicle 1 and to transmit the 3D mapping data to the vehicle controller 3. The vehicle controller 3 is configured to specify the surrounding environment information, based on the transmitted 3D mapping data.

The HMI 8 includes an input unit configured to receive an input operation from a driver and an output unit configured to output the traveling information and the like toward the driver. The input unit includes a steering wheel, an accelerator pedal, a brake pedal, a driving mode changeover switch for switching the driving mode of the vehicle 1, and the like. The output unit is a display for displaying a variety of traveling information. The GPS 9 is configured to acquire current position information of the vehicle 1 and to output the acquired current position information to the vehicle controller 3.

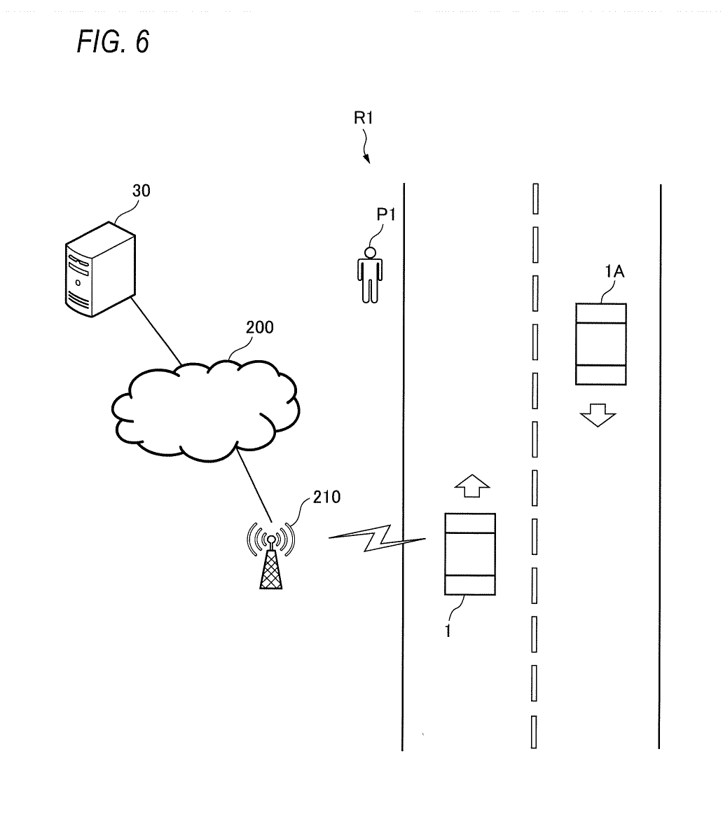

The wireless communication unit 10 is configured to receive information (for example, traveling information, and the like) relating to other vehicles around the vehicle 1 from the other vehicles and to transmit information (for example, traveling information, and the like) relating to the vehicle 1 to the other vehicles (inter-vehicle communication). Also, the wireless communication unit 10 is configured to receive infrastructure information from the infrastructure equipment such as a traffic light, a marker lamp and the like and to transmit the traveling information of the vehicle 1 to the infrastructure equipment (road-to-vehicle communication). Also, the wireless communication unit 10 is configured to receive information relating to a pedestrian from a portable electronic device (a smart phone, a tablet, a wearable device, and the like) carried by the pedestrian and to transmit the host vehicle traveling information of the vehicle 1 to the portable electronic device (pedestrian-to-vehicle communication). The vehicle 1 may be configured to perform communication with the other vehicle, the infrastructure equipment or the portable electronic device by an ad hook mode directly or via an access point. Also, the vehicle 1 may be configured to perform communication with the other vehicle, the infrastructure equipment or the portable electronic device via a communication network 200 (refer to FIG. 6). Here, the communication network 200 includes at least one of the Internet, a local area network (LAN), a WAN and a wireless access network (RAN). The wireless communication standards include, for example, Wi-Fi (registered trademark), Bluetooth (registered trademark), ZigBee (registered trademark), LPWA, DSRC (registered trademark) or Li-Fi. Also, the vehicle 1 may be configured to perform communication with the other vehicle, the infrastructure equipment or the portable electronic device via a fifth generation (5G) mobile communication system.

The storage device 11 is an external storage device such as a hard disc drive (HDD), an SSD (Solid State Drive) and the like. In the storage device 11, the 2D or 3D map information, illumination specification data (which will be described later) and/or the vehicle control program may be stored. For example, the 3D map information may be configured by the point group data. The storage device 11 is configured to output the map information and the vehicle control program to the vehicle controller 3, in response to a request from the vehicle controller 3. The map information, the vehicle control program and/or the illumination specification data may be updated via the wireless communication unit 10 and the communication network 200 (refer to FIG. 6).

When the vehicle 1 travels in an autonomous driving mode, the vehicle controller 3 automatically generates at least one of a steering control signal, an accelerator control signal and a brake control signal, based on the traveling condition information, the surrounding environment information, the current position information, the map information and the like. The steering actuator 12 is configured to receive the steering control signal from the vehicle controller 3 and to control the steering device 13 on the basis of the received steering control signal. The brake actuator 14 is configured to receive the brake control signal from the vehicle controller 3 and to control the brake device 15 on the basis of the received brake control signal. The accelerator actuator 16 is configured to receive the accelerator control signal from the vehicle controller 3 and to control the accelerator device 17 on the basis of the received accelerator control signal. In this way, the vehicle controller 3 automatically controls the traveling of the vehicle 1, based on the traveling condition information, the surrounding environment information, the current position information, the map information and the like. That is, in the autonomous driving mode, the traveling of the vehicle 1 is automatically controlled by the vehicle system 2.

On the other hand, when the vehicle 1 travels in a manual driving mode, the vehicle controller 3 generates a steering control signal, an accelerator control signal and a brake control signal in conformity with a driver's manual operation on the accelerator pedal, the brake pedal and the steering wheel. In this way, in the manual driving mode, the steering control signal, the accelerator control signal and the brake control signal are generated by the driver's manual operation, so that the traveling of the vehicle 1 is controlled by the driver.

Subsequently, the driving mode of the vehicle 1 is described. The driving mode includes an autonomous driving mode and a manual driving mode. The autonomous driving mode includes a fully autonomous driving mode, an advanced driving support mode, and a driving support mode. In the fully autonomous driving mode, the vehicle system 2 is configured to automatically perform all of the traveling controls of the steering control, the brake control and the accelerator control, and the driver is not in a state where it is possible to drive the vehicle 1. In the advanced driving support mode, the vehicle system 2 is configured to automatically perform all of the traveling controls of the steering control, the brake control and the accelerator control, and the driver does not drive the vehicle 1 although the driver is in a state where it is possible to drive the vehicle 1. In the driving support mode, the vehicle system 2 is configured to automatically perform a part of the traveling controls of the steering control, the brake control and the accelerator control, and the driver drives the vehicle 1 under the driving support of the vehicle system 2. On the other hand, in the manual driving mode, the vehicle system 2 is configured not to automatically perform the traveling controls, and the driver drives the vehicle 1 without the driving support of the vehicle system 2.

Also, the driving mode of the vehicle 1 may be switched by operating a driving mode changeover switch. In this case, the vehicle controller 3 is configured to switch the driving mode of the vehicle 1 among the four driving modes (the fully autonomous driving mode, the advanced driving support mode, the driving support mode, and the manual driving mode) in accordance with a driver's operation on the driving mode changeover switch. Also, the driving mode of the vehicle 1 may be automatically switched on the basis of information relating to a travel-allowed section where traveling of an autonomous driving vehicle is allowed or a travel-prohibited section where the traveling of the autonomous driving vehicle is prohibited or information relating to the external weather condition. In this case, the vehicle controller 3 is configured to switch the driving mode of the vehicle 1, based on such information. Also, the driving mode of the vehicle 1 may be automatically switched by using a seating sensor, a face direction sensor, or the like. In this case, the vehicle controller 3 is configured to switch the driving mode of the vehicle 1, based on an output signal from the seating sensor, the face direction sensor and/or the breath sensor.

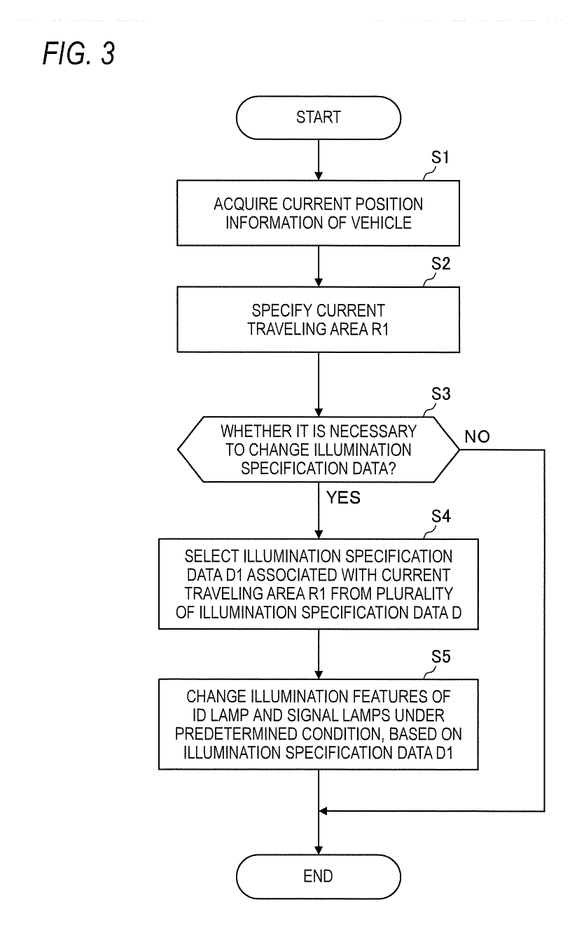

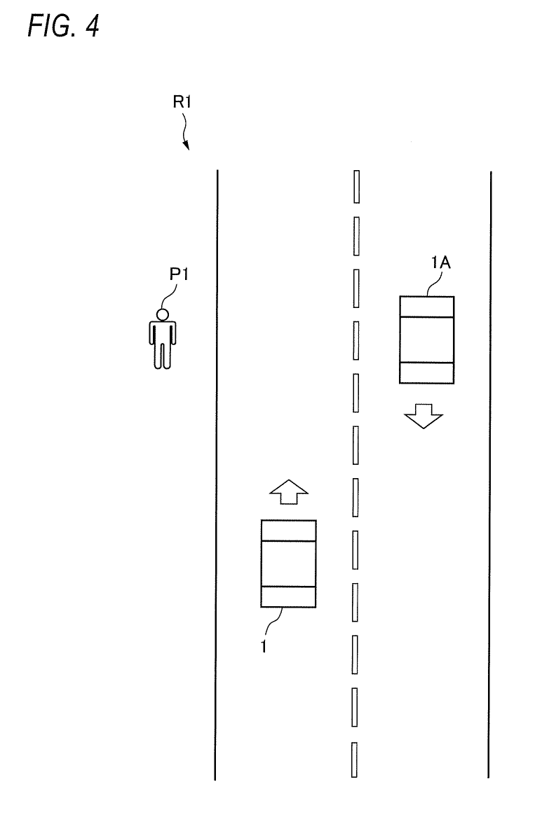

Subsequently, a first operation example of the vehicle system 2 is described with reference to FIGS. 3 and 4. FIG. 3 is a flowchart depicting the first operation example of the vehicle system 2. FIG. 4 depicts the vehicle 1 located in a current traveling area R1. In the first operation example of the vehicle system 2, illumination specification data D1 associated with the current traveling area R1 is selected from a plurality of illumination specification data stored in the vehicle 1.

As shown in FIG. 3, the vehicle controller 3 first acquires the current position information of the vehicle 1 by using the GPS 9 (step S1). Then, the vehicle controller 3 specifies the current traveling area R1 in which the vehicle 1 is currently located, based on the map information stored in the storage device 11 and the current position information of the vehicle 1 (step S2). Here, the current traveling area R1 is prescribed as a country, a county, a state, a province, a city, a center (for example, a theme-park, a shopping mall and the like) or a road (for example, an autonomous driving vehicle road and the like). For example, when the vehicle 1 is currently located in Japan and the current traveling area R1 is prescribed as a country, the vehicle controller 3 specifies the current traveling area R1, as Japan.

Then, after the vehicle controller 3 transmits information indicative of the current traveling area R1 to the illumination controller 43, the illumination controller 43 determines whether it is necessary to change illumination specification data D being currently used, based on the current traveling area R1 (step S3). Here, the illumination specification data D is data indicative of the illumination feature (an illumination color, turning on or off, a blinking cycle, a luminosity or the like) of the ADS lamp (the ID lamp 42 and the signal lamps 40R, 40L) under a predetermined condition. Here, an example of “the illumination feature of the ADS lamp under the predetermined condition” is described.
the illumination features of the ID lamp 42 when the driving mode of the vehicle 1 is the advanced driving support mode or the fully autonomous driving mode
the illumination features of the signal lamps 40R, 40L when the vehicle 1 stops
the illumination features of the signal lamps 40R, 40L when the vehicle 1 starts
the illumination features of the signal lamps 40R, 40L when the vehicle 1 gives way to the pedestrian and the like
the illumination features of the signal lamps 40R, 40L when the vehicle 1 changes traffic lanes

Also, the illumination specification data D may be associated with the traveling area. That is, each of the plurality of illumination specification data D may be associated with one of a plurality of traveling areas. In this respect, the traveling area may be prescribed as a country, a county, a state, a province, a city, a center or a road. For example, when the traveling area is prescribed as a country, each of the plurality of illumination specification data D may be associated with one of a plurality of countries. In this case, the illumination specification data D for each country may be stored in the memory of the illumination controller 43 or the storage device 11. Also, when the traveling area is prescribed as a county, each of the plurality of illumination specification data D may be associated with one of a plurality of counties. In this case, the illumination specification data D for each county may be stored in the memory of the illumination controller 43 or the storage device 11.

When it is determined that it is necessary to change illumination specification data D being currently used (YES in step S3), the illumination controller 43 executes processing of step S4. On the other hand, when it is determined that it is not necessary to change illumination specification data D being currently used (NO in step S3), the illumination controller 43 ends the processing. For example, it is assumed that the current traveling area R1 is prescribed as a country and the vehicle 1 has moved from A country to B country. At this time, when the illumination specification data for A country and the illumination specification data for B country are different, the illumination controller 43 determines that it is necessary to change the illumination specification data for A country being currently used to the illumination specification data for B country. On the other hand, when the illumination specification data for A country and the illumination specification data for B country are the same, the illumination controller 43 determines that it is not necessary to change the illumination specification data. Also, when the current traveling area R1 is prescribed as a country and the vehicle 1 still remains in the A country (i.e., the current traveling area R1 is not changed), the illumination controller 43 determines that it is not necessary to change the illumination specification data.

Then, when a determination result in step S3 is YES, the illumination controller 43 selects illumination specification data D1 (an example of the first illumination specification data) associated with the current traveling area R1 from the plurality of illumination specification data D stored in the memory, based on the current traveling area R1 (step S4). In the above example, the illumination controller 43 selects the illumination specification data D1 associated with the B country from the plurality of illumination specification data D, based on the current traveling area R1 corresponding to the B country.

Thereafter, the illumination controller 43 changes the illumination feature of the ADS lamp (the ID lamp 42 and the signal lamps 40R, 40L) under the predetermined condition, based on the illumination specification data D1 associated with the current traveling area R1 (step S5). Here, an example of “the illumination feature of the ADS lamp under the predetermined condition” has been already described. For example, it is assumed that an illumination color of the ID lamp 42 is yellow in the A country when the driving mode of the vehicle 1 is the advanced driving support mode or the fully autonomous driving mode and an illumination color of the ID lamp 42 is white in the B country when the driving mode of the vehicle 1 is the advanced driving support mode or the fully autonomous driving mode. Here, in the case where the vehicle 1 has moved from the A country to the B country, the illumination controller 43 changes the illumination color of the ID lamp 42 from yellow to white when the driving mode of the vehicle 1 is the advanced driving support mode or the fully autonomous driving mode, based on the illumination specification data for B country. In this way, the illumination controller 43 is configured to change the illumination feature of the ADS lamp under the predetermined condition, in correspondence to the current traveling area R1.

According to the illustrative embodiment, the illumination feature of the ADS lamp under the predetermined condition is changed, in correspondence to the current traveling area R1 in which the vehicle 1 is currently located. Therefore, it is possible to provide the illumination system 4 capable of implementing optimal visual communication corresponding to each traveling area. In this way, the vehicle 1 can perform appropriate visual communication with the other vehicle 1A or pedestrian P1 (refer to FIG. 4) existing in the current traveling area R1 by using the ADS lamp.

Also, according to the illustrative embodiment, the illumination specification data D1 associated with the current traveling area R1 is selected from the plurality of illumination specification data D, and the illumination feature of the ADS lamp under the predetermined condition is then changed on the basis of the selected illumination specification data D1. In this way, even when the vehicle 1 does not have a wireless communication function or cannot normally perform wireless communication with the external server, it is possible to implement optimal visual communication corresponding to each traveling area.

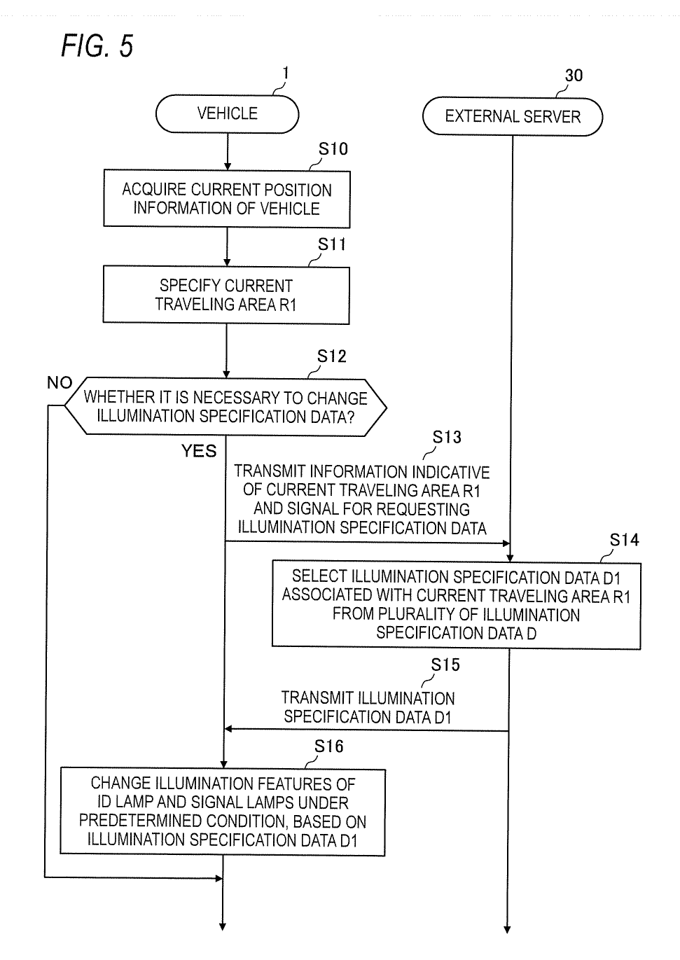

Subsequently, a second operation example of the vehicle system 2 is described with reference to FIGS. 5 and 6. FIG. 5 is a flowchart depicting the second operation example of the vehicle system 2. FIG. 6 depicts the vehicle 1 located in the current traveling area R1 and an external server 30 provided on the communication network 200. In the second operation example of the vehicle system 2, the illumination specification data D1 associated with the current traveling area R1 is acquired from the outside. As described above, the current traveling area R1 is prescribed as a country, a county, a state, a province, a city, a center or a road in which the vehicle 1 is currently located.

As shown in FIG. 5, the vehicle controller 3 of the vehicle 1 acquires the current position information of the vehicle 1 by using the GPS 9 (step S10). Then, the vehicle controller 3 specifies the current traveling area R1 in which the vehicle 1 is currently located, based on the map information stored in the storage device 11 and the current position information of the vehicle 1 (step S11). Then, in step S12, the vehicle controller 3 determines whether it is necessary to change the illumination specification data D being currently used, based on the current traveling area R1. When it is determined that it is necessary to change the illumination specification data D being currently used (YES in step S12), the vehicle controller 3 executes processing of step S13. On the other hand, when it is determined that it is not necessary to change the illumination specification data D being currently used (NO in step S12), the vehicle controller 3 ends the processing. The illumination specification data D being currently used is stored in the memory (RAM) of the illumination controller 43, for example.

Then, when a determination result in step S12 is YES, the vehicle controller 3 transmits the information indicative of the current traveling area R1 and a signal (hereinafter, referred to as ‘request signal’) for requesting the illumination specification data to the external server 30 on the communication network 200 via the wireless communication unit 10 (step S13). The request signal transmitted from the wireless communication unit 10 of the vehicle 1 is transmitted to the external server 30 via a base station 210 and the communication network 200. Here, the external server 30 may be a cloud server on the Internet or an edge server on the RAN.

Then, the external server 30 receives the information indicative of the current traveling area R1 and the request signal. Thereafter, the external server 30 selects the illumination specification data D1 (an example of the first illumination specification data) associated with the current traveling area R1 from the plurality of illumination specification data D stored in a storage device of the external server 30, based on the current traveling area R1 (step S14). Here, the storage device of the external server 30 is, for example, an HDD or SSD.

Then, the external server 30 transmits the illumination specification data D1 to the vehicle 1 via the communication network 200 (step S15). Then, the vehicle controller 3 of the vehicle 1 receives the illumination specification data D1 via the wireless communication unit 10, and transmits the illumination specification data D1 to the illumination controller 43. Thereafter, the illumination controller 43 changes the illumination feature of the ADS lamp (the ID lamp 42 and the signal lamps 40R, 40L) under the predetermined condition, based on the illumination specification data D1 (step S16).

According to the illustrative embodiment, the illumination feature of the ADS lamp under the predetermined condition is changed on the basis of the illumination specification data D1 received from the external server 30 outside the vehicle 1. In this way, even when the plurality of illumination specification data D for each traveling area is not stored in the vehicle 1, it is possible to implement the optimal visual communication corresponding to each traveling area. Also, even when the illumination specification data D1 is updated with a predetermined frequency, the vehicle 1 can acquire the latest illumination specification data D1 from the external server 30. In this way, the vehicle 1 can perform appropriate visual communication with the other vehicle 1A and the pedestrian P1 (refer to FIG. 6) existing in the current traveling area R1 by using the ADS lamp.

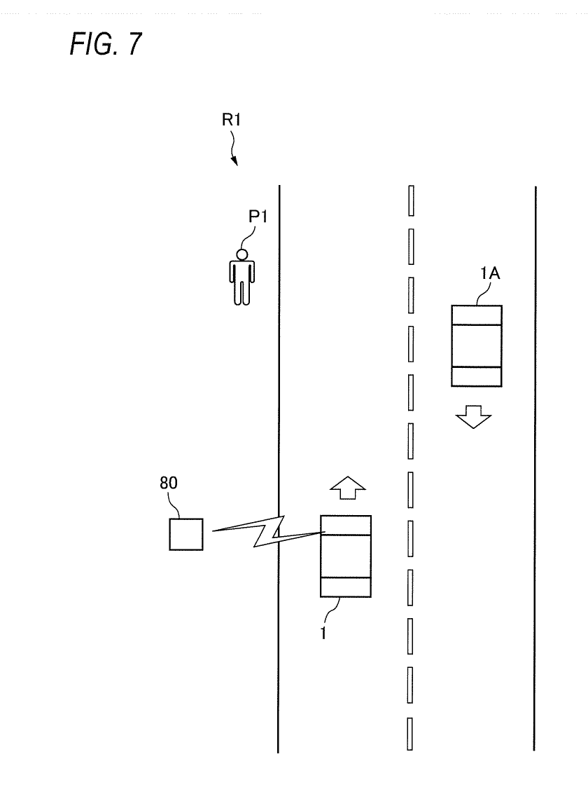

In the meantime, in the above example, the illumination specification data D1 is transmitted from the external server 30 on the communication network 200 to the vehicle 1. However, the illustrative embodiment is not limited thereto. For example, as shown in FIG. 7, the vehicle 1 may directly receive the illumination specification data D1 from an infrastructure equipment 80 around the vehicle 1. Specifically, the vehicle 1 establishes communication with the infrastructure equipment 80 and then receives the illumination specification data D1 from the infrastructure equipment 80. Then, the vehicle controller 3 of the vehicle 1 transmits the illumination specification data D1 to the illumination controller 43, and then the illumination controller 43 changes the illumination feature of the ADS lamp under the predetermined condition, based on the illumination specification data D1. In this modified embodiment, since the infrastructure equipment 80 is arranged in the current traveling area R1, the illumination specification data D1 transmitted from the infrastructure equipment 80 is associated with the current traveling area R1. For this reason, the vehicle 1 does not have to transmit the information indicative of the current traveling area R1 to the traffic infrastructure equipment 80 when acquiring the illumination specification data D1. In this way, when receiving the illumination specification data D1 from the infrastructure equipment 80 arranged in the current traveling area R1, the vehicle 1 does not have to specify the current traveling area R1. Also, when the current traveling area R1 is prescribed as a country, the infrastructure equipment 80 may be arranged in the vicinity of a national border. When the current traveling area R1 is prescribed as a road, the infrastructure equipment 80 may be arranged in the vicinity of a merging point between a main traffic lane and a merging traffic lane. Also, when the current traveling area R1 is prescribed as a center (a theme-park and the like), the infrastructure equipment 80 may be arranged in the vicinity of an entry of the center.

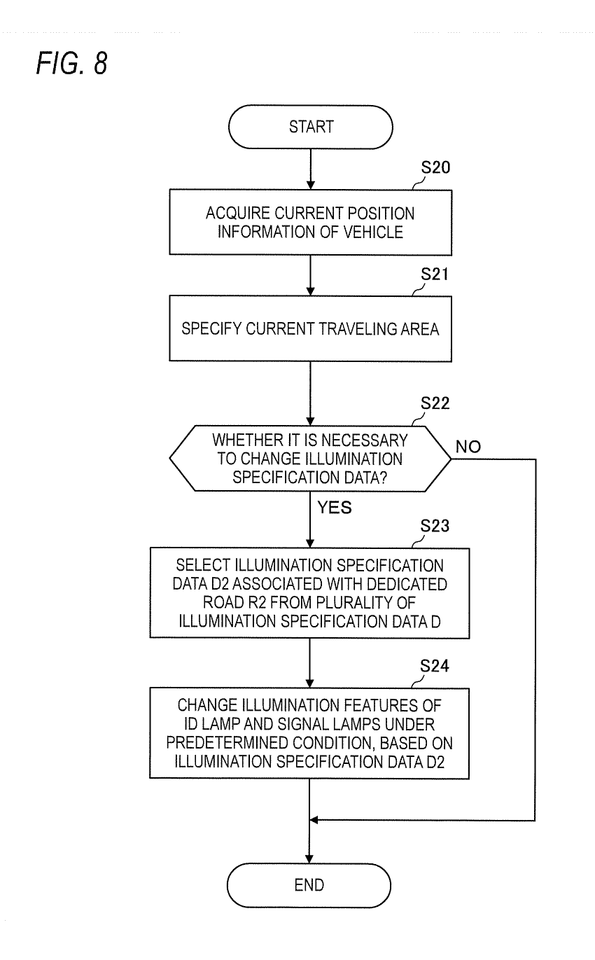

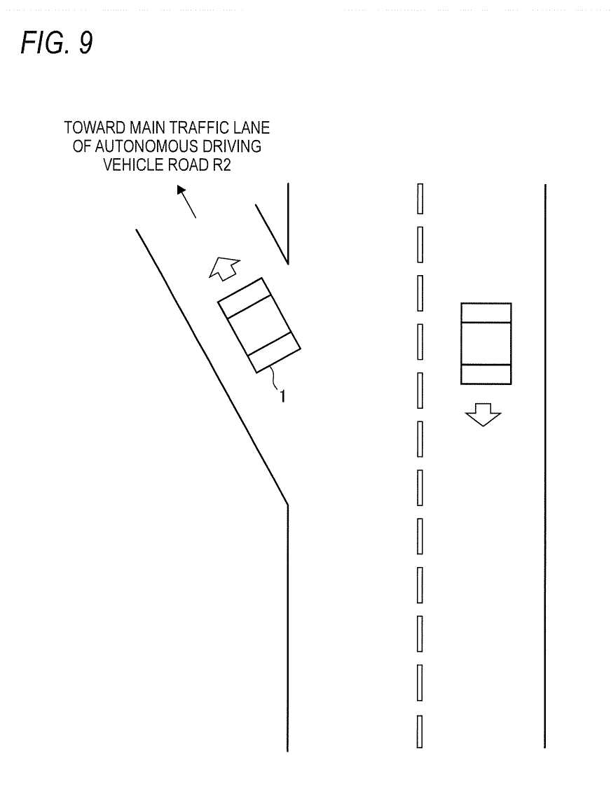

Subsequently, an operation example of the vehicle system 2 is described which is executed when the current traveling area and the traveling area are prescribed as a road and the vehicle 1 travels on an autonomous driving vehicle road R2 (hereinafter, referred to as ‘dedicated road R2’), with reference to FIGS. 8 and 9. FIG. 8 is a flowchart depicting an operation example of the vehicle system 2, which is executed when the vehicle 1 travels on the dedicated road R2. FIG. 9 depicts the vehicle 1 passing an entry of the dedicated road R2. In this example, each of the plurality of illumination specification data D is associated with one of a plurality of roads. The illumination specification data D for each road is stored in the memory of the illumination controller 43 or the storage device 11. Also, it is assumed that the illumination specification data D of a general road and the illumination specification data D2 of the dedicated road R2 are different from each other.

As shown in FIG. 8, the vehicle controller 3 acquires the current position information of the vehicle 1 by using the GPS 9 (step S20), and specifies the current traveling area as the dedicated road R2, based on the current position information of the vehicle 1 and the map information (step S21). Then, the vehicle controller 3 transmits information indicative of the dedicated road R2 to the illumination controller 43. Thereafter, the illumination controller 43 determines whether it is necessary to change the illumination specification data D of the general road being currently used, based on the information indicative of the dedicated road R2 (step S22). In this example, since the illumination specification data D of the general road and the illumination specification data D2 of the dedicated road R2 are different from each other, the illumination controller 43 determines that it is necessary to change the illumination specification data D of the general road being currently used to the illumination specification data D2 of the dedicated road R2 (YES in step S22).

Then, the illumination controller 43 selects the illumination specification data D2 associated with the dedicated road R2 from the plurality of illumination specification data D stored in the memory, based on the information indicative of the dedicated road R2 (step S23). Thereafter, the illumination controller 43 changes the illumination feature of the ADS lamp (the ID lamp 42 and the signal lamps 40R, 40L) under the predetermined condition, based on the illumination specification data D2 associated with the dedicated road R2 (step S24).

According to the illustrative embodiment, when the vehicle 1 travels on the dedicated road R2, the illumination feature of the ADS lamp under the predetermined condition is changed. In this way, it is possible to implement the optimal visual communication corresponding to the dedicated road R2.

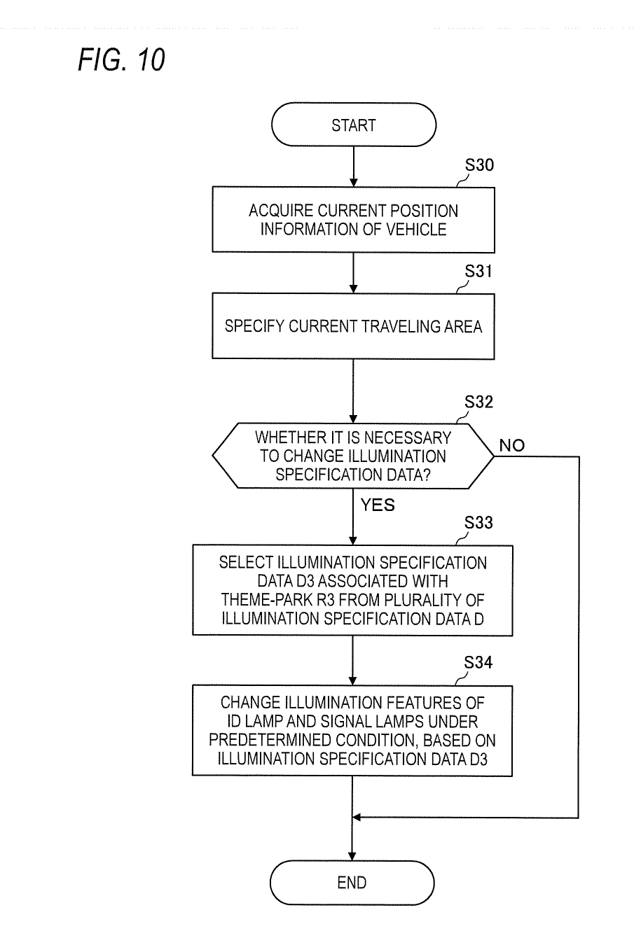

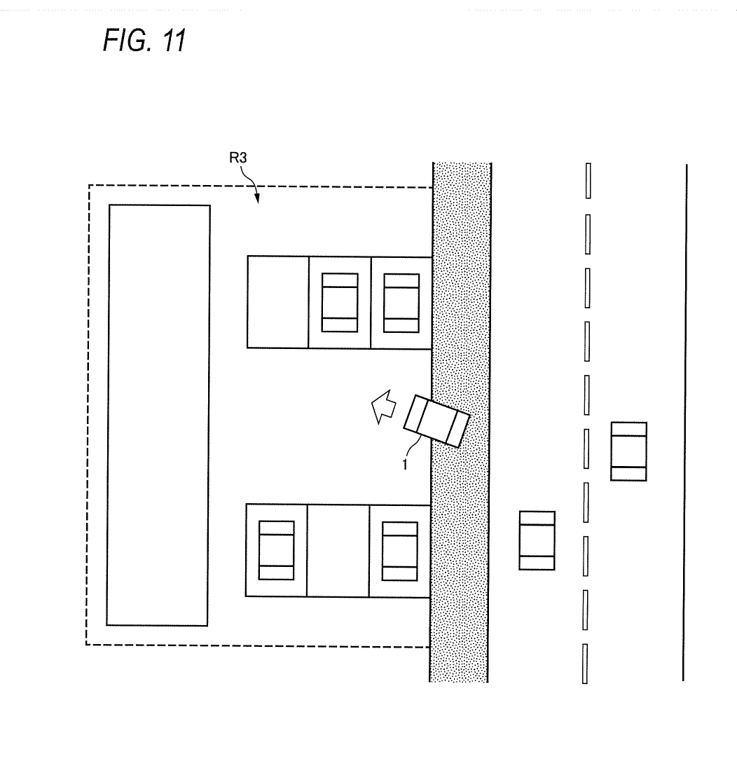

Subsequently, an operation example of the vehicle system 2 is described which is executed when the current traveling area and the traveling area are prescribed as a center and the vehicle 1 travels in a theme-park R3 (an example of the predetermined center), with reference to FIGS. 10 and 11. FIG. 10 is a flowchart depicting an operation example of the vehicle system 2, which is executed when the vehicle 1 travels in the theme-park R3. FIG. 11 depicts the vehicle 1 passing an entry of the theme-park R3. In this example, each of the plurality of illumination specification data D is associated with one of a plurality of centers. The illumination specification data D for each center is stored in the memory of the illumination controller 43 or the storage device 11. Also, it is assumed that when the vehicle 1 travels on the road, the illumination specification data D of the road is used. It is assumed that the illumination specification data D of the road and the illumination specification data D3 of the theme-park R3 are different from each other.

As shown in FIG. 10, the vehicle controller 3 acquires the current position information of the vehicle 1 by using the GPS 9 (step S30), and specifies the current traveling area as the theme-park R3, based on the current position information of the vehicle 1 and the map information (step S31). Then, the vehicle controller 3 transmits information indicative of the theme-park R3 to the illumination controller 43. Thereafter, the illumination controller 43 determines whether it is necessary to change the illumination specification data D of the road being currently used, based on the information indicative of the theme-park R3 (step S32). In this example, since the illumination specification data D of the road and the illumination specification data D3 of the theme-park R3 are different from each other, the illumination controller 43 determines that it is necessary to change the illumination specification data D of the road being currently used to the illumination specification data D3 of the theme-park R3 (YES in step S32).

Then, the illumination controller 43 selects the illumination specification data D3 associated with the theme-park R3 from the plurality of illumination specification data D stored in the memory, based on the information indicative of the theme-park R3 (step S33). Thereafter, the illumination controller 43 changes the illumination feature of the ADS lamp (the ID lamp 42 and the signal lamps 40R, 40L) under the predetermined condition, based on the illumination specification data D3 associated with the theme-park R3 (step S34).

According to the illustrative embodiment, when the vehicle 1 travels in the theme-park R3, the illumination feature of the ADS lamp under the predetermined condition is changed. In this way, it is possible to implement the optimal visual communication corresponding to the traveling in the theme-park R3.

In the meantime, in the operation examples of the vehicle system 2 shown in FIGS. 8 and 10, the illumination specification data associated with the current traveling area is selected from the plurality of illumination specification data stored in the memory of the illumination controller 43. However, the illumination specification data associated with the current traveling area may be acquired from the outside (for example, an external server and the like) of the vehicle 1 via wireless communication.

Although the illustrative embodiments of the present disclosure have been described, it goes without saying that the technical scope of the present disclosure should not be interpreted limitedly by the descriptions of the illustrative embodiments. It will be understood by one skilled in the art that the illustrative embodiments are just exemplary and that the illustrative embodiments can be diversely changed within the scope of the invention defined in the claims. The technical scope of the present disclosure should be determined on the basis of the scope of the invention defined in the claims and its equivalent scope.

In the illustrative embodiment, the driving mode of the vehicle includes the fully autonomous driving mode, the advanced driving support mode, the driving support mode, and the manual driving mode. However, the driving mode of the vehicle should not be limited to the four modes. The classification of the driving mode of the vehicle may be appropriately changed, in accordance with laws or rules relating to the autonomous driving in each country. Likewise, the definitions of “the fully autonomous driving mode”, “the advanced driving support mode” and “the driving support mode” described in the illustrative embodiments are just examples, and may be appropriately changed, in accordance with laws or rules relating to the autonomous driving in each country.

The embodiments are summarized as follows.

A vehicle illumination system related to one aspect of the present disclosure and provided to a vehicle capable of traveling in an autonomous driving mode includes: an autonomous driving system (ADS) lamp configured to emit light toward an outside of the vehicle, thereby visually presenting information relating to an autonomous driving of the vehicle, and an illumination controller configured to change an illumination feature of the ADS lamp under a predetermined condition, in correspondence to a current traveling area in which the vehicle is currently located.

According to the above configuration, the illumination feature of the ADS lamp under the predetermined condition is changed in correspondence to the current traveling area in which the vehicle is currently located. In this way, it is possible to provide the vehicle illumination system capable of implementing optimal visual communication corresponding to each traveling area.

Moreover, the illumination controller may be configured to change the illumination feature of the ADS lamp under the predetermined condition, based on first illumination specification data associated with the current traveling area.

According to the above configuration, the first illumination specification data associated with the current traveling area is used, so that it is possible to implement the optimal visual communication corresponding to each traveling area.

Moreover, the illumination controller may be configured: to select the first illumination specification data from a plurality of illumination specification data each of which is associated with one traveling area, based on current position information of the vehicle; and to change the illumination feature of the ADS lamp under the predetermined condition, based on the selected first illumination specification data.

According to the above configuration, the first illumination specification data associated with the current traveling area is selected on the basis of the current position information of the vehicle, and the illumination feature of the ADS lamp under the predetermined condition is changed on the basis of the selected first illumination specification data. Thus, even when the vehicle does not have a wireless communication function or it is not possible to normally perform wireless communication between the vehicle and an external server, it is possible to implement the optimal visual communication corresponding to each traveling area.

Moreover, the vehicle illumination system may further include a wireless communication unit configured to receive the first illumination specification data. The illumination controller may be configured to change the illumination feature of the ADS lamp under the predetermined condition, based on the received first illumination specification data.

According to the above configuration, the illumination feature of the ADS lamp under the predetermined condition is changed, based on the first illumination specification data received from the outside. Thus, even when the plurality of illumination specification data for each traveling area is not stored in the vehicle, it is possible to implement the optimal visual communication corresponding to each traveling area. Also, the vehicle illumination system can acquire the latest first illumination specification data from the outside.

Moreover, the current traveling area may be prescribed as a country, a prefecture, a state, a province, a city, a center or a road in which the vehicle is currently traveling.

According to the above configuration, the illumination feature of the ADS lamp under the predetermined condition is changed, in correspondence to the country, the county, the state, the province, the city, the center or the road in which the vehicle is currently traveling. In this way, it is possible to implement the optimal visual communication corresponding to the country, the county, the state, the province, the city, the center or the road.

Moreover, the current traveling area may be prescribed as the road in which the vehicle is currently traveling, and when the vehicle travels on an autonomous driving vehicle road, the illumination controller may change the illumination feature of the ADS lamp under the predetermined condition.

According to the above configuration, when the vehicle travels on the autonomous driving vehicle road, the illumination feature of the ADS lamp under the predetermined condition is changed. In this way, it is possible to implement the optimal visual communication corresponding to the autonomous driving vehicle road.

Moreover, the current traveling area may be prescribed as the center in which the vehicle is currently traveling, and when the vehicle travels in a predetermined center, the illumination controller may change the illumination feature of the ADS lamp under the predetermined condition.

According to the above configuration, when the vehicle travels in the predetermined center (a theme-park and the like), the illumination feature of the ADS lamp under the predetermined condition is changed. In this way, it is possible to implement the optimal visual communication corresponding to the traveling in the predetermined center.

A vehicle comprising the above-mentioned vehicle illumination system, which is capable of traveling in an autonomous driving mode, is provided.

According to the above configuration, it is possible to provide the vehicle capable of implementing optimal visual communication corresponding to each traveling area.

According to the present disclosure, it is possible to provide the vehicle illumination system and the vehicle capable of implementing optimal visual communication corresponding to each traveling area.

1. A vehicle illumination system provided to a vehicle capable of traveling in an autonomous driving mode, the vehicle illumination system comprising:
an autonomous driving system (ADS) lamp configured to emit light toward an outside of the vehicle, thereby visually presenting information relating to an autonomous driving of the vehicle; and
an illumination controller configured to change an illumination feature of the ADS lamp under a predetermined condition, in correspondence to a current traveling area in which the vehicle is currently located.

2. The vehicle illumination system according to claim 1, wherein the illumination controller is configured to change the illumination feature of the ADS lamp under the predetermined condition, based on first illumination specification data associated with the current traveling area.

3. The vehicle illumination system according to claim 2, wherein the illumination controller is configured:
to select the first illumination specification data from a plurality of illumination specification data each of which is associated with one traveling area, based on current position information of the vehicle; and
to change the illumination feature of the ADS lamp under the predetermined condition, based on the selected first illumination specification data.

4. The vehicle illumination system according to claim 2, further comprising a wireless communication unit configured to receive the first illumination specification data,
wherein the illumination controller is configured to change the illumination feature of the ADS lamp under the predetermined condition, based on the received first illumination specification data.

5. The vehicle illumination system according to claim 1, wherein the current traveling area is prescribed as a country, a prefecture, a state, a province, a city, a center or a road in which the vehicle is currently traveling.

6. The vehicle illumination system according to claim 5, wherein
the current traveling area is prescribed as the road in which the vehicle is currently traveling, and
when the vehicle travels on an autonomous driving vehicle road, the illumination controller changes the illumination feature of the ADS lamp under the predetermined condition.

7. The vehicle illumination system according to claim 5, wherein
the current traveling area is prescribed as the center in which the vehicle is currently traveling, and
when the vehicle travels in a predetermined center, the illumination controller changes the illumination feature of the ADS lamp under the predetermined condition.

8. A vehicle including a vehicle illumination system and capable of traveling in an autonomous driving mode, the vehicle illumination system comprising:
an autonomous driving system (ADS) lamp configured to emit light toward an outside of the vehicle, thereby visually presenting information relating to an autonomous driving of the vehicle; and
an illumination controller configured to change an illumination feature of the ADS lamp under a predetermined condition, in correspondence to a current traveling area in which the vehicle is currently located.
